(19) United States
(12) Patent Application Publication
(10) Pub. No.: US 2018/0354012 A1
(43) Pub. Date: Dec. 13, 2018

(54) MACHINE DEVICE AND MACHINING METHOD WITH RELATIVELY MOVED MACHINE TOOLS

(71) Applicant: Mall + Herlan Schweiz AG, Weinfelden (CH)

(72) Inventors: Manfred WEIS, Radolfzell (DE); Mathias PETER, Herxheim (DE)

(73) Assignee: Mall + Herlan Schweiz AG, Weinfelden (CH)

(21) Appl. No.: 16/003,292

(22) Filed: Jun. 8, 2018

(30) Foreign Application Priority Data
Jun. 9, 2017 (DE) 10 2017 112 771.2

(51) Int. Cl. B21D 19/04; B23Q 5/20

(52) U.S. Cl. CPC B21D 19/043; B23Q 5/20

(57) ABSTRACT

A machining device for an element to be machined includes a moving unit, a machining unit and a control element. The moving unit is provided with an acceleration unit. The control element and the acceleration unit are designed so that a movement of at least one part of the acceleration unit with at least one component of movement transverse to the direction of movement of the moving unit is mechanically associated with a movement of the moving unit relative to the control element. The acceleration unit is designed so that producing a relative acceleration of the machining unit in relation to the moving unit in the direction of movement of the moving unit is mechanically associated with the movement of at least said part of the acceleration unit.

### CROSS REFERENCE TO RELATED APPLICATIONS

Applicant claims priority under 35 U.S.C. § 119 of German Application No. 10 2017 112 771.2 filed Jun. 9, 2017, the disclosure of which is incorporated by reference.

### BACKGROUND OF THE INVENTION

### 1. Field of the Invention

The present invention relates to the field of machining devices and methods of machining with relatively moved tools and in particular to machining devices and methods of machining in which machining is performed during cyclical movement of a moving unit by means of a machining unit whose relative speed relative to an element to be machined is less than that of the moving unit and is preferably (approximately) zero.

The present invention is specifically relevant for the machining of metal containers, for example aerosol canisters, beverage containers and the like.

### 2. Description of the Related Art

When producing metal containers, for example aerosol canisters, the shoulders are generally produced in a sequential, linear and typically axially parallel forming process, the draw and iron process. The respective tools in the machine (the draw and iron press) are fixed in a corresponding receptacle which is normally moved intermittently through the machine and along the longitudinal axis of the containers to be formed, with the tools engaging the container during part of the movement. The part of the movement during which the tools (may) engage with the containers is generally called the “stroke”.

However, there are also some special steps in the process which perform, for example, a rotating working motion superimposed upon the linear movement, e.g. milling, flange rolling, thread rolling or bead rolling.

In many cases in which these superimposed movements are performed, the linear movement of the machine is used to displace shaped elements or other machining elements (e.g. blades) towards the workpiece to be machined, by using a normally immovable stop member in the rotating part of the tool. This is called “activation”.

Such rotating processes have been identified as a primary factor due to which the speed of production is limited to less that the potential maximum speed of the machine.

Two main aspects are important in this regard, namely the time available to the device, within the linear movement, to perform the rotating process over the container, and the speed at which the device strikes the container, with a secondary factor being the weight that strikes the container.

In known approaches, a very simple form of this activation consists in a part of the device which is linearly moveable inside the device contacting the partially or completely shaped container before the dead center of machine movement is reached, being stopped by the container and then being pushed relative to the device which is coupled to the machine. This pushing is then implemented via a cam in mostly radial movement of shaped elements, in order to perform the actual work step of the device. The centrifugal force of the rotating shaped or other working elements is normally sufficient for them to be pressed against the outer control cam during the prestroke and the return stroke.

It is clear that the loads that the container must withstand in such an approach will increase with increasing speed of the machine, and that the time available for performing the work step becomes shorter.

Another option that is used for heavier devices is to provide an external stop member against which a part of the device extended axially to the rear or to the front strikes, or also a stop member acting laterally, which then takes over the function of the container. One consequence of this is that the container is no longer exposed to the reaction forces from the delay, which means that a greater number of cycles can be achieved, but a shaped element produced in this way is no longer positioned relative to the container, but relative to the stop member. Irrespective of any concomitant sensitivity to variations in the length of the container, which may be controllable, the impact of the entire mass on the stop member causes high levels of stress, not only in the stop member itself, but also in the machine.

It is possible to dampen this impact, for example by means of an air damper, which also provides the advantage that its damping effect increases with speed. However, such systems are difficult to design and/or to control, because even the smallest changes in clearance or temperature can cause changes in the behavior of the damper. The problem involved has less to do with the behavior of the damper itself, and more to do with activation being moved to a different location, with the result that it not possible to ensure with sufficient reliability that the actual work process of the device takes place at the desired location (in respect of the container).

Another, more recent approach is to place an active drive means between the device and the machine, which moves the entire device relative to the machine in such a way that the impact speed of the device when it strikes the container is reduced, despite the higher cycle rate of the machine.

There are limits here as well, due in particular to the installable output, the installation space available and the power to weight ratio of such active drive means.

A similar approach is applied in concepts in which the movement of such rotating devices is completely decoupled and separately performed from the machine.

However, there are limits here as well, due to the installation space available, the adjustability of the device and the susceptibility to vibration caused by the rotation of the device. Moreover, retrofitting such a drive means in order to increase the speed is costly and complicated.

It can be assumed, with regard to present-day machines which operate at high speeds, that the limitation imposed on output due to the machining which is superimposed on the linear movement and which necessitates braking (and subsequent acceleration) of part of the device, is still around 60% to 80% of the maximum possible machine speed.

### SUMMARY OF THE INVENTION

One aim of the present invention is to avoid the limitations and disadvantages described above and to provide a way of utilizing the output limits of the machine tools themselves.

The desire is therefore to present a solution with which a machining device and the corresponding method for machining with relatively moved tools are no longer limited solely by the capacity limits associated with the relative movement of the tools, in particular in relation to the elements to be machined.

According to a first aspect of the invention, a machining device for an element to be machined, in particular a metal container, is proposed, namely a machining device comprising a moving unit designed to perform a cyclical movement, in particular, a machining unit which is designed to be moveable relative to the moving unit at least in the direction of movement of the moving unit inside the machining device and which is designed to machine the element to be machined with a relative speed, in the direction of movement relative to the element to be machined, which is reduced in comparison with that of the moving unit, in particular to zero, and a control element, wherein the moving unit is provided with an acceleration unit, wherein the control element and the acceleration unit are designed in such a way that a movement of at least one part of the acceleration unit with at least one component of movement transverse to the direction of movement of the moving unit is mechanically associated with a movement of the moving unit, and wherein the acceleration unit is designed in such a way that producing a relative acceleration of the machining unit in relation to the moving unit in the direction of movement of the moving unit is mechanically associated with the movement of at least said part of the acceleration unit.

According to a second aspect of the invention, a method of machining an element to be machined, in particular a metal container, is proposed, said method comprising the steps of moving, in particular cyclically moving, a moving unit and machining the element to be machined with a relative speed, in the direction of movement relative to the element to be machined, which is reduced in comparison with that of the moving unit, in particular to zero, by a machining unit which is designed to be moveable relative to the moving unit at least in the direction of movement of the moving unit inside the machining device, wherein the method further comprises the steps of mechanically producing a movement of at least a part of an acceleration unit of the moving unit with at least one component of movement transverse to the direction of movement of the moving unit, by means of a relative movement of the moving unit in relation to a control element when moving the moving unit and mechanically producing a relative acceleration of the machining unit in relation to the moving unit in the direction of movement of the moving unit, by moving at least said part of the acceleration unit.

The aim is to produce working conditions, ideally without using external energy, from the components of the machine movement and the container that are always present even in the simplest case, which allow the use of devices (e.g. rotating devices) up to the output limit of the machine itself in the production of aerosol canisters or the like. Even though it is particularly preferred that no external energy is used, this should not be understood to mean that such use is necessarily ruled out.

Depending on what is possible or necessary, it should still be possible for the respective system to operate with spatial exactitude, so that the final states are always adopted at the same location and with a high level of repeat accuracy, wherein the repeat accuracy can also be addressed in certain variants of the invention by means of secondary measures outside the actual concept of the invention.

Variants of the inventions allow existing systems to be retrofitted, due to the small amount of installation space required.

The problem with approaches known so far that use stop members is that the kinetic energy for stopping the device must be absorbed either by the containers being machined or by an external stop member. This reduces the maximum attainable speed and the service life of the device. Known approaches which use compensating movements all require additional energy and must be controlled electronically, but even in such cases the maximum speed limits are generally not exploited yet.

The present invention allows a reduction in the impact energy, without costly and time-consuming complexity of use, by appropriately utilizing the motion sequences and movements which are also included in the design, but which have not yet been utilized.

In one advantageous embodiment of one aspect of the invention, the control element is part of an activating unit which is coupled to the moving unit and is adapted to contact the element to be machined. In a preferred variant of this embodiment, the activating unit has a lower mass than the machining unit, in particular a mass less than 50% of the mass of the machining unit, preferably a mass ranging from 5% to 40% of the mass of the machining unit.

This embodiment is advantageous in that it allows activation to be performed directly on the element to be machined and within the moved part of the device. In this embodiment, the element to be machined (e.g. a metal container) and the machining device (or the machining unit) are brought into contact in a process which is split into at least two phases. In the first phase, the activating unit, which is a significantly lighter part of the device in comparison with the actual machining unit, strikes the container. The mass and the impact speed of this light part of the device can be calculated so that they do not cause any damage to the container on impact. This means that, after this initial contact, there are elements in the machining device that move relative to each other. Via a motion deflection mechanism, the invention now makes it possible to generate, from the first relative movement, an acceleration of the machining unit, as a second, generally heavier part of the device, without the ensuing reaction forces acting on the container becoming so great that damage is caused to the container.

In another advantageous embodiment of one aspect of the invention, the machining device comprises a holding device for the element to be machined, wherein the control element is part of an activating unit which is arranged stationarily in relation to the holding device in at least the direction of movement of the moving unit.

Even in the case of a complete redesign, there may be boundary conditions which render it impossible or difficult to have a variant in which the activating unit is moved along with the moving unit relative to the element to be machined. This may apply all the more when an existing machining device is retrofitted within the meaning of the invention. For such cases in particular, the invention also allows a different way of influencing the speed, in which the manipulation is not achieved by producing a relative movement of two parts in relation to each other within the complex of the moving unit itself, but by controlling an external manipulation device in conjunction with the main movement and an external stop member.

It should be noted that the invention also provides a phased acceleration effect, so that it is possible, for example with the aid of a first control element which is stationary relative to the element to be machined, and a corresponding first acceleration unit, to exert an influence on a combination of a control means with a second control element and a corresponding second acceleration unit, such that this kind of accelerated combination (which is braked in the one direction of movement, for example) has an accelerating effect (e.g. one that brakes even more) on the machining unit, wherein said control means rests on the container to be machined.

In another advantageous embodiment of one aspect of the invention, the acceleration unit has a pick-off element which forms a cam mechanism with the control element as cam carrier, wherein the acceleration unit is designed to impart the relative acceleration mechanically to the machining unit, in particular by a levering effect produced by moving the pick-off element.

In the context of the invention, it is possible, for example in connection with the activating unit coupled to the moving unit, that a cam, or a plurality of cams distributed on the circumference, is/are mounted on the part that is initially moved relative to the device (a similar principle applies accordingly in the case of an activating unit which is stationary in relation to the element to be machined). While the first part is still moving on its own, said cam then runs, for example, under a contact element of a lever which is itself mounted rotatably and which is displaced about that pivot point by the shape of the cam. The mainly radial displacement is converted in the lever into axial movement elsewhere, where it is transmitted via another contact element to the second, usually heavier part of the device, namely the machining unit. Whereas the speed of the first, light part of the device (the activating unit) changes abruptly when it comes into contact with the container, the change in speed of the second part (of the machining unit) is stretched out over a defined range in this variant of the invention, with the result that the resultant momentum is greatly reduced. By appropriately designing the cams and the geometry of the lever, it is also possible that, after a defined acceleration phase of the second part, the first part comes into direct contact with the second part almost without any difference in speed—i.e. almost without any jolting—and can transfer its movement 1:1 to the second part.

In one advantageous embodiment of the invention, said pivot point is fixed in position relative to the movement of machinery in the machining device.

In one preferred variant of the above embodiment, the pick-off element is guided along the cam carrier by means of a guide, and/or the pick-off element is provided with a spring which presses the pick-off element onto the cam carrier.

In another advantageous embodiment of one aspect of the invention, the acceleration unit transfers exclusively kinetic energy from the moving unit exclusively to the machining unit and exclusively kinetic energy from the machining unit exclusively to the moving unit.

In another advantageous embodiment of one aspect of the invention, the machining unit is adapted for machining rotatingly about an axis the element to be machined, in particular about an axis parallel to the direction of movement of the moving unit, in particular for milling, flange rolling, thread rolling and/or bead rolling.

In another advantageous embodiment of one aspect of the invention, the movement of the moving unit is a cyclical movement with a movement forth and a movement back, wherein the movement forth is provided to move the machining unit to the element to be machined, and the relative acceleration of the machining unit in relation to the moving unit involves braking the machining unit, wherein the movement back is provided to move the machining unit away from the element to be machined, and the relative acceleration of the machining unit in relation to the moving unit involves accelerating the machining unit.

Features of advantageous embodiments of the invention are discussed below, in particular, and a person skilled in the art can also find other advantageous features, embodiments and variants of the invention in the above description and the discussion below.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIGS. 1A, 1B, 1C, 1D, and 15 show schematic views to illustrate a first embodiment of a machining device according to the invention,

FIGS. 2A, 2B, 2C, 2D, 2E, and 2F show schematic views to illustrate a second embodiment of a machining device according to the invention,

FIG. 3 shows a schematic flow diagram of an embodiment of the machining method according to the invention,

FIGS. 4A and 4B show schematic views to illustrate a third embodiment of a machining device according to the invention,

FIGS. 5A and 5B show schematic views to illustrate a fourth embodiment of a machining device according to the invention,

FIGS. 6A and 6B show schematic views to illustrate a fifth embodiment of a machining device according to the invention,

FIG. 7 shows a schematic view to illustrate a sixth embodiment of a machining device according to the invention.

### DETAILED DESCRIPTION OF PREFERRED EMBODIMENTS

In the enclosed drawings and in the associated descriptions of said drawings, corresponding or related elements are given corresponding or similar reference signs, where expedient, even when they are to be found in different embodiments.

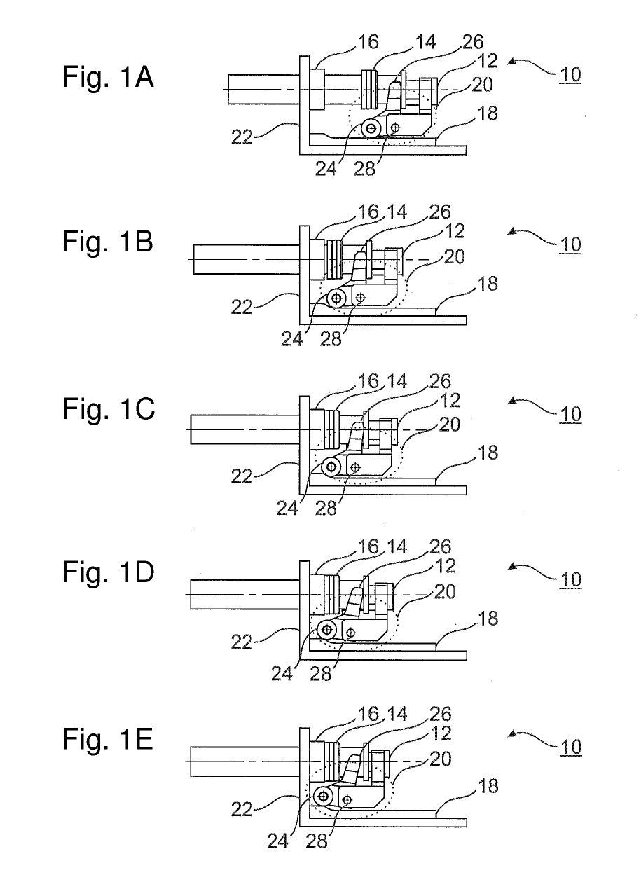

FIGS. 1A, 1B, 1C, 1D, and 15 show schematic views to illustrate a first embodiment of a machining device 10 according to the invention, or to be more exact, FIG. 1A to FIG. 1E each show different states in the motion sequence of machining device 10.

Machining device 10 comprises a moving unit 12, a machining unit 14, a control element 18, an acceleration unit 20, a holding device 22, a pick-off element 24, a lever 26 and a pivot axis 28.

Holding device 22 is provided with a stop member 16 for machining unit 14, wherein the element to be machined (not shown here; arranged in the left in the views shown in FIGS. 1A, 1B, 1C, 1D, and 1E) comes into contact with machining unit 14 when the latter abuts or makes contact with stop member 16 (or shortly before that).

Control element 18 is attached in the form of a cam carrier to holding device 22 in such a way that holding device 22 can also be seen in this regard as a control means which carries control element 18.

Pick-off element 24, which is connected to lever 26, is in contact with control element 18, so any movement of pick-off element 24 (produced by control element 18) results in lever 26 being pivoted about pivot axis 28.

Machining unit 14 is supported by moving unit 12, however it is moveable in relation to the moving unit along its direction of movement.

Pick-off element 24, and lever 26 with its pivot axis 28, are part of acceleration unit 20, which is provided on moving unit 12.

FIG. 1A shows machining device 10 in a state in which machining unit 14 is distant from the element to be machined (e.g. an extreme position in a stroke of moving unit 12, which moves, in the view shown in FIGS. 1A, 1B, 1C, 1D, and 1E, from right to left and back again in its cyclical motion).

In FIG. 1B, due to the movement of moving unit 12 to the left, machining unit 14 is positioned just in front of stop member 16 (and thus shortly before the element to be machined, which is further to the left and outside the view shown here). In the longitudinal direction of control element 18, pick-off element 24, too, is just in front of the beginning of a cam by which pick-off element 24 is deflected (upwards in the view shown in the drawing).

In FIG. 1C, it can be seen that, due to the continued movement to the left of moving unit 12 in relation to FIG. 1B, pick-off element 24 has been moved upwards by the cam of control element 18, the latter movement being converted by the corresponding pivoting of lever 26 about pivot axis 28 into a movement of the end of lever 26 opposite pick-off element 24, wherein said end of the lever acts on machining unit 14 to brake its motion in relation to stop member 16.

In FIG. 1D, which is the continuation of FIG. 1C, pick-off element 24 has reached the end of the cam of control element 18, which means that lever 26 has also stopped pivoting, and due to the combination of the pivoting movement of lever 26 and the movement of moving unit 12, the machining unit strikes stop member 16 (and thus the element to be machined, which is not shown here) with a speed which is reduced relative to the speed of moving unit 12.

The cam of control element 18 is not a hard stop, so machining unit 14 can be set down onto stop member 16 with a certain residual amount of momentum which is then dimensioned in such a way that the element to be machined is not damaged by it. However, it may also be arranged that lever 26 comes to a halt, with the result that lever 26 itself acts as a stop. As an alternative to the embodiment shown in FIGS. 1A, 1B, 1C, 1D, and 1E, in which stop member 16 is provided, it is also possible to do without such a stop member, which means that machining unit 14 can also be set down directly onto the element to be machined. In all these cases, the interaction of the cam of control element 18 with acceleration unit 20 can be designed in such a way that machining unit 14 is set down on the element to be machined with a residual momentum of (practically) zero.

It can be seen from FIG. 15 that lever 26 has moved away from machining unit 14 due to the continued movement of moving element 12, and the position of moving element 12 may, for example, be the extreme position of the stroke opposite the position shown in FIG. 1A.

The reverse movement and the corresponding process inside machining device 10 can also be seen with reference to FIGS. 1A to 1E.

When moving unit 12 moves to the right, pick-off element 24 follows the cam of control element 18 such that the end of lever 26 opposite pick-off element 24 lags behind the movement of moving element 12, preferably coming almost to a standstill in the region where it comes into contact with machining unit 14. When moving element 12 continues to move, the end of lever 26 catches up in terms of (absolute) speed) with the moving element as a whole, due to continued control via the cam of control element 18, with the result that when machining unit 14 is carried along, it does not experience any strong, jolting acceleration, but rather a smaller amount of acceleration over a longer period of time.

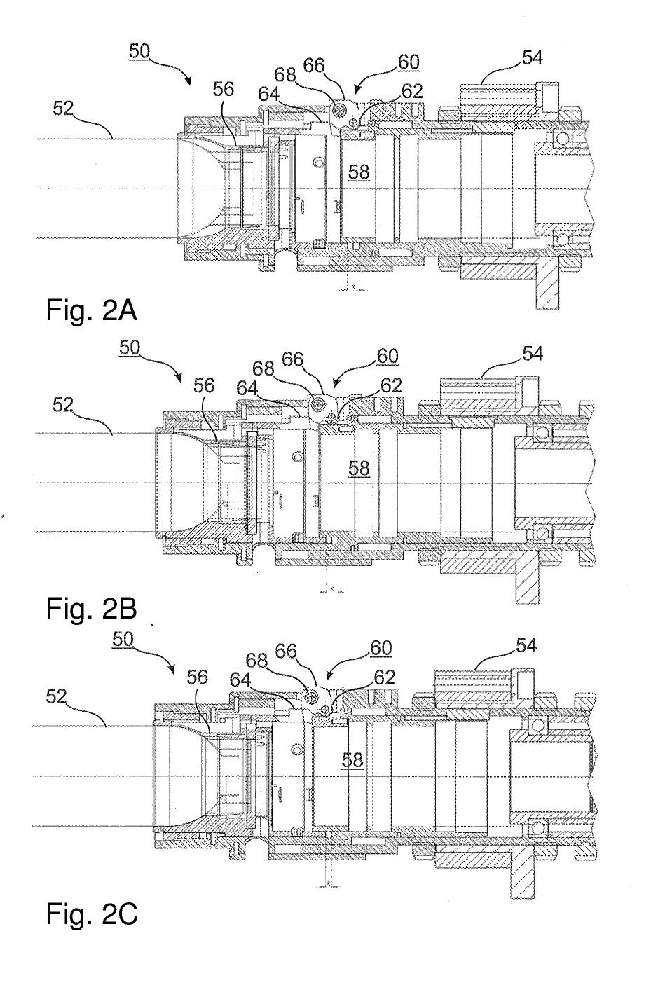

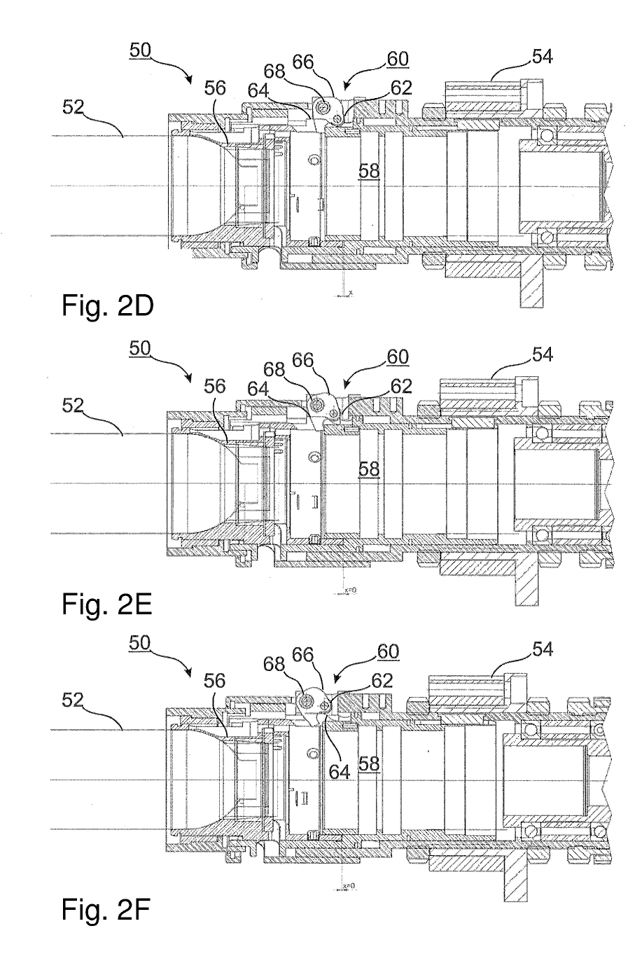

FIGS. 2A, 2B, 2C, 2D, 2E, and 2F show schematic views to illustrate a second embodiment of a machining device 50 according to the invention. To be more exact, FIG. 2A to FIG. 2F each show different states in the motion sequence of machining device 50.

Machining device 50 comprises a moving unit 54, an activating unit 56, a control element 64, a machining unit 58 and an acceleration unit 60 comprising a pick-off element 62, a lever 66 and a pivot axis 68.

Unlike in FIGS. 1A, 1B, 1C, 1D, and 1E, activating unit 56 is provided here so that, when the machining device moves, it sets down on an element 52 to be machined (shown here in the form of a bottle), with the result that there is a defined relationship between the end position of the element 52 to be machined and control element 64 of the activating unit, regardless of any other dimensioning or positioning of the element 52 to be machined.

The manner of operation and the interaction of control element 64 (which has a cam), pick-off element 62, lever 66 and pivot axis 68 are otherwise the same as in the aspects already discussed with reference to FIGS. 1A, 1B, 1C, 1D, and 1E, so there is no need to discuss them any further here. It should be noted that, in the view shown in FIGS. 2A, 2B, 2C, 2D, 2E, and 2F, the lever is shown as “transparent” in order not to cover the path of the cam of control element 64.

FIG. 2A shows machining device 50 in a position that is distant from the element 52 to be machined. In FIG. 2B, activating unit 56 is set down on the element 52 to be machined. In FIG. 2C, it can be seen from the distance (“x”) between activating unit 56 and machining unit 58 that machining unit 58 has moved further and jointly with moving unit 54. FIG. 2D shows that lever 66 has been pivoted by the deflection of pick-off element 62 on the cam of control element 64 about pivot axis 68, thus causing machining unit 58 to accelerate (with a negative acceleration relative to moving unit 54, that is to say with a braking effect). It can be seen by comparing FIG. 2C and FIG. 2D that machining unit 58 lags behind moving unit 54 accordingly. FIG. 2E shows the situation in which machining unit 58 sets down on activating unit 56 (and thus on element 52 to be machined) (“x=0”), whereas FIG. 2F shows a later position in which moving unit 54 has moved as far further relative to machining unit 58 that lever 66 is released from machining unit 58.

The kinematic reversal described above with reference to FIGS. 1A, 1B, 1C, 1D, and 15 also applies analogously when movement is in the opposite direction.

The aspects to be taken into consideration when designing the cam guide (in its interaction with the rest of the mechanism, such as the acceleration unit) include the braking section (for example the end of lever 26 in FIGS. 1A, 1B, 1C, 1D, and 1E) ideally having a desired (maximum) speed along the direction of movement of the moving unit (in the case of a can as an example of an element to be machined, in the can's axial direction and away from the can) which cancels out the speed when travelling over the cam (just about/exactly or at least to a significant degree), so that in the extreme case it comes to a standstill (or at least to a substantially reduced speed on contact) due to the combination and/or superimposition of the movements. The respective point for this standstill or for the minimum speed must be set in such a way that the machining unit comes into contact in the process with a stop member or with the element to be machined.

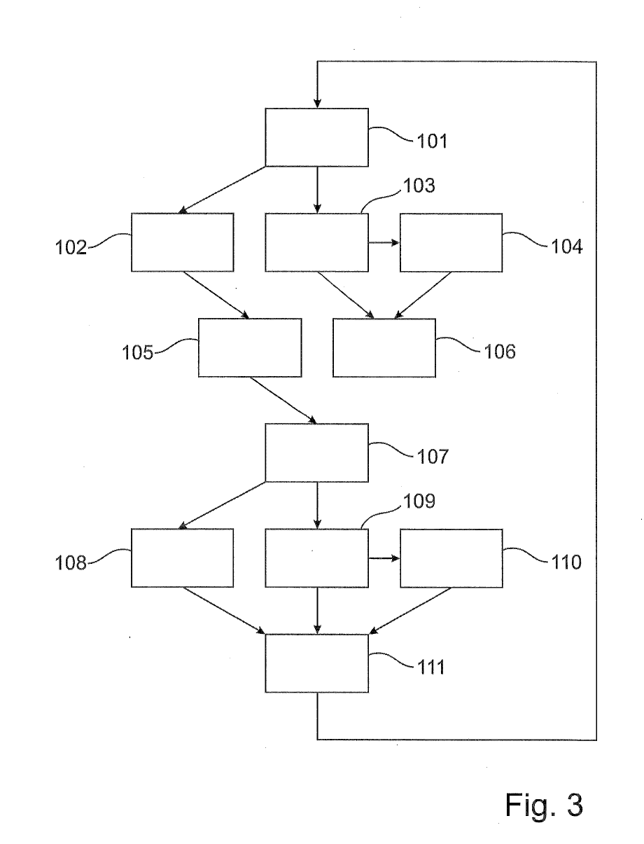

FIG. 3 shows a schematic flow diagram of an embodiment of the machining method according to the invention.

The method firstly comprises moving 101 the moving unit as a whole, with its respective units.

In step 102, this movement is continued, but parallel to that a movement of at least a part of an acceleration unit of the moving unit is mechanically effected 103 by movement of the moving unit relative to a control element, with at least one component of movement transverse to the direction of movement of the moving unit, and in step 104, due to the movement of at least said part of the acceleration unit, a relative acceleration of the acceleration unit relative to the moving unit is effected in the direction in which the moving unit moves.

Steps 103 and 104 result in the machining unit arriving with a reduced impact at the element to be machined (see FIG. 1D or FIG. 2E, for example), so it is possible to machine the element to be machined in step 106, while the moving unit continues to move in step 105.

The direction in which the moving unit moves is reversed with step 107.

In step 108, that movement, too, is continued, but parallel to that a movement of at least a part of an acceleration unit of the moving unit is mechanically effected 109 by movement of the moving unit relative to a control element, with at least one component of movement transverse to the direction of movement of the moving unit, and in step 110, due to the movement of at least that part of the acceleration unit, a relative acceleration of the acceleration unit relative to the moving unit is effected in the direction in which the moving unit moves. What happens, in other words, is that the acceleration unit is braked, because it starts its movement before there is any contact between the stop member/the element to be machined and the machining unit.

The movement or acceleration in steps 109 and 110, respectively, is opposite in each case to the movement or acceleration in steps 103 and 104.

In step 111, there is movement of the moving unit as a whole, but in a direction opposite to that in step 101. The method can be continued after a reversal at the other end of the stroke.

Although the method is described here with movement 101 as the starting point, the invention is not limited to that. It is possible, in particular, to begin with steps 107-111, to continue with steps 101-106 and then to continue that cycle again with step 107 and the steps that follow.

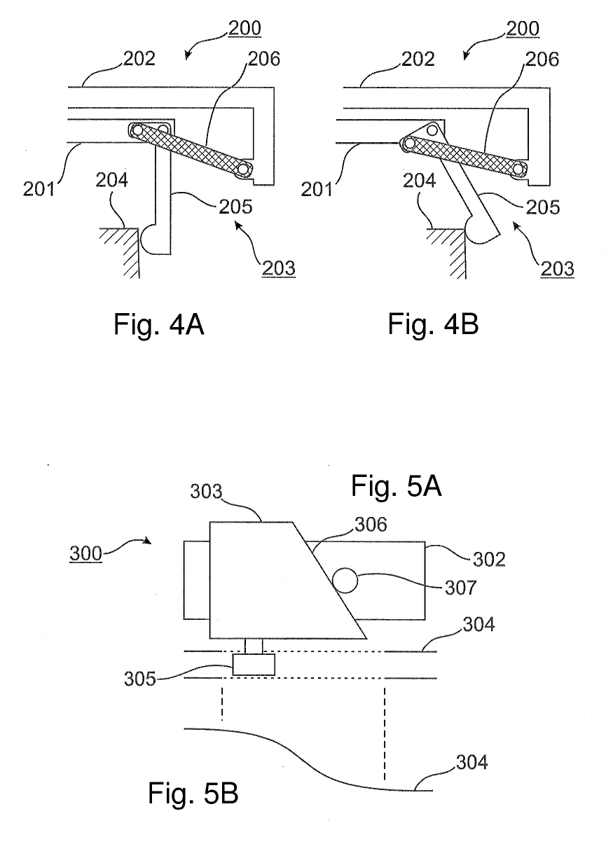

FIGS. 4A and 4B show schematic views to illustrate a third embodiment of a machining device according to the invention. This view of the machining device 200 in this embodiment is limited to the aspects that are relevant here for the description.

Machining device 200 comprises a moving unit 201 and a machining unit 202, which are coupled to other via an acceleration unit 203.

FIG. 4A shows a position or status of machining device 200 in which a contact lever 205 is not yet in contact with a control element 204 designed as a stop member (but this is no longer the case if moving unit 201 moves to the left or if moving unit 201 moves to the right).

Contact lever 205 is L-shaped and is pivotably joined at the corner of its leg to moving unit 201. The longer of the two legs is provided to come into contact with control element 204.

At the end of the shorter of the two legs of contact lever 205, an arm 206 is pivotably mounted, which for its part is pivotably joined to machining unit 202.

FIG. 4B shows a view in which the end of contact lever 205 stays behind when moving unit 201 moves to the left, due to contact with control element 204. Contact lever 205 is pivoted thereby in relation to moving unit 201, and this pivoting results in a relative movement of machining unit 202, due to the coupling via arm 206.

FIGS. 5A and 5B show a schematic view to illustrate a fourth embodiment of a machining device according to the invention. In this case also, the view of machining device 300 in this embodiment is limited to the aspects that are relevant for the description here.

Machining device 300 is provided with a machining unit 302 and an acceleration unit 303 (as part of a moving unit which is otherwise not shown). Machining unit 302 has a substantially cylindrical section which is arranged here inside a matching and substantially cylindrical section of acceleration unit 303. Acceleration unit 303 has a slanting shoulder 306 which in contact here with a roller 307 of machining unit 302. A cam 304 is also provided, which is designed to guide acceleration unit 303 via a pick-off element 305 to rotate acceleration unit 303 about its longitudinal axis (which is horizontal in the plane of the drawing in FIG. 5A). Cam 304, the path of which is shown in FIG. 5B), extends in an outer surface around machining unit 302 and acceleration unit 303.

When acceleration unit 303 is moved to the left in the view shown in FIG. 5A, cam 304 causes clockwise rotation of acceleration unit 304 when viewed from the right along the longitudinal axis of acceleration unit 303. As machining unit 302 is guided in such a way that it does not rotate along with acceleration unit 303, a relative movement of machining unit 302 to the right in relation to acceleration unit 303 is produced by roller 307 rolling on the shoulder, with the result that machining unit 302 is braked in relation to the movement of acceleration unit 303 to the left.

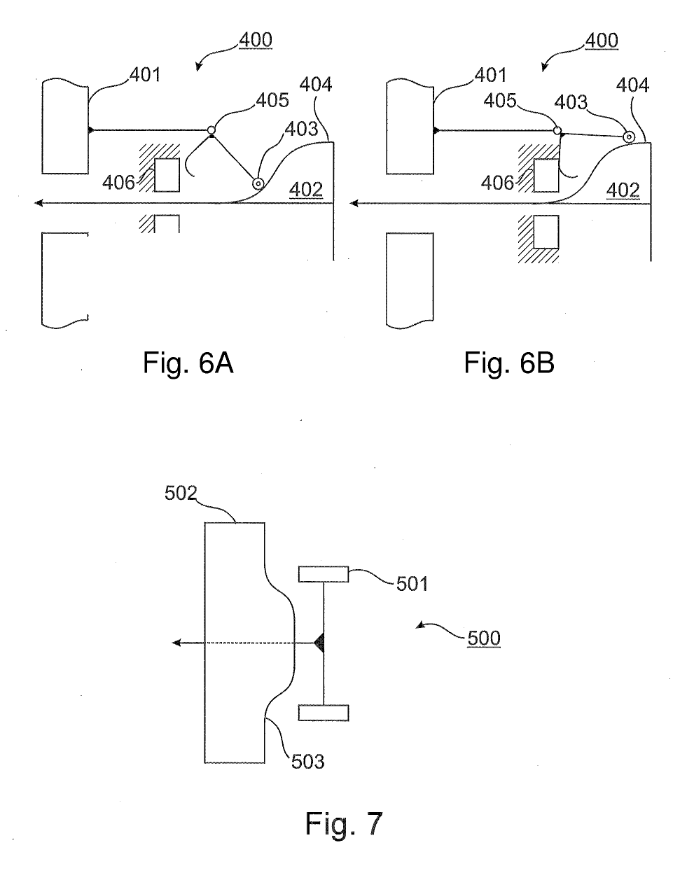

FIGS. 6A and 6B show schematic views to illustrate a fifth embodiment of a machining device according to the invention. In this case also, the view of machining device 400 in this embodiment is limited to the aspects that are relevant for the description here.

In addition to machining unit 402, which is provided with a cam carrier 404, machining device 400 comprises a moving unit 401 which is provided with a pivotably mounted follower 403, said follower 403 being designed to cooperate with cam carrier 404.

Follower 403 is held by an L-shaped carrier 405 at the end of a leg, the end of the other leg being provided to abut against a stop member 406.

As can be seen from the combination of FIG. 6A and FIG. 6B, when the carrier, or its other end, strikes stop member 406, this causes the cam carrier to pivot, which leads in turn, via follower 403 and cam carrier 404, to a relative movement of machining unit 402 in relation to moving unit 401.

FIG. 7 shows a schematic view to illustrate a sixth embodiment of a machining device according to the invention. In this case also, the view of machining device 500 in this embodiment is limited to the aspects that are relevant for the description here.

The machining unit of machining device 500, of which only the moving unit and a follower unit 501 are shown, is moved relative to a stop member 502 which rotates coaxially with the direction of motion of the machining unit and has a linear cam 503 on the side facing follower unit 501. The rotation of stop member 502 is coordinated in such a way that follower unit 501, which is fixed in its rotational position relative to the direction of movement of the machining unit, comes into contact with linear cam 503 at a shoulder thereof, and is then braked by the interaction of the rotation of linear cam 503, the shape of linear cam 503 and the follower unit rolling on the contour of linear cam 503 moving underneath it. The same applies, in a kinetic reversal, for acceleration in the opposite direction of movement. Stop member 502 can preferably be made to rotate by appropriately converting the movement of the moving unit itself, and it is also possible in that regard for stop member 502 to be separately driven.

Even if different aspects or features of the invention are shown in combination in the Figures, it is clear to a person skilled in the art, unless other specified, that the combinations shown and discussed are not the only ones possible. More particularly, it is possible to swap corresponding units or groups of features from different embodiments.

Some further remarks shall now be made regarding certain aspects of the invention.

The invention allows differences in the axially parallel speeds of bodies moving relative to each other to be manipulated at the moment they come into contact, for example in machines for machining metal containers, so that the speed of one part of the device is changed (delayed) in such a way that the momentum on impact is minimized by a system that advantageously is purely mechanical. The two moving parts may be arranged axially parallel, and it is preferable that no external energy or control input is needed in order to influence their movement.

In advantageous embodiments of the invention, in order to reduce differences in the speed of bodies which are being moved relative to one another in machines for machining metal containers, for example, in which activation is performed directly on the body in question, the body to be influenced is split into two parts having different weights, the first, lighter part being used as a primary activation generator which initially experiences an abrupt change in speed itself and which then causes a slow change in speed in the second, heavier part as a result of its relative movement in relation to said second part of the body. An advantageous layout may provide that the relative speed between the primary activation generator and the second part of the body is near zero at the moment of contact. In preferred embodiments, there are cam elements on a first, protruding part of the body, which deflect a transmission lever by contact along the cam, after the first, protruding part has reached its final position, due to the relative movement which then ensues between said first part and the second part of the body which is still being moved along with the general movement of the machine, the movement of said transmission lever being transmitted elsewhere on the same lever in a different direction to the second part of the body, wherein the initiated movement of the transmission lever can be advantageously performed predominantly at right angles to the movement of the first part of the body. The derived movement for the second part of the body is predominantly axially parallel to the movement of the first part.

In another embodiment for reducing differences in the speed of bodies which are being moved relative to one another in machines for machining metal containers, with activation performed outside the actual device, the movement of the device is manipulated in such a way, by a cam segment which is moved with the main movement of the machine, that the momentum at the moment the device meets the external stop member is minimized, and/or the stop member is accelerated in such a way in the body's direction of movement, before impact of the body and by a mechanism which is coupled to the movement of the machine, that there no difference in speed between the stop member and the body when they come into contact and that the stop member is braked after that to the standstill position with the body resting against it. It is particularly desired that the impact speed of the device is almost zero at the moment it strikes the external stop member, and/or that the impact speed of the stop member into its final position is almost zero at the moment it reaches its final position.

The invention makes it possible to reduce differences in the speed of bodies which are being moved relative to one another in machines for machining metal containers, wherein a stop member supported by a lever is in a waiting position, and said stop member is accelerated via the lever in such a way in a specific phase of the machine cycle, under the control of a cam segment which is moved in step with the movement of the machine, that a device which is moved in step with the movement of the machine strikes the moving stop member with a difference in speed that is almost zero, and that the stop member is braked after that into its final position while still controlled via the lever and the cam segment. The movement of the transmission lever is initiated predominantly at right angles to the movement of the first part of the body, for example, and it can also be provided that the movement derived for the second part of the body is predominantly axially parallel to the movement of the first part.

Although only a few embodiments of the present invention have been shown and described, it is to be understood that many changes and modifications may be made thereunto without departing from the spirit and scope of the invention.

### LIST OF REFERENCE SIGNS

10 Machining device
12 Moving unit
14 Machining unit
16 External stop member
18 Control element
20 Acceleration unit
22 Holding device
24 Pick-off element
26 Lever
25 Pivot axis
50 Machining device
52 Element to be machined
54 Moving unit
56 Activating unit
58 Machining unit
60 Acceleration unit
62 Pick-off element
64 Control element
66 Lever
68 Pivot axis
101 Move the moving unit
102 Move the moving unit
103 Make a part of the acceleration unit move
104 Produce a relative acceleration of the machining unit
105 Move the moving unit
106 Machine the element to be machined
107 Move the moving unit
108 Move the moving unit
109 Make a part of the acceleration unit move
110 Produce a relative acceleration of the machining unit
111 Move the moving unit
200 Machining device
201 Moving unit
202 Machining unit
203 Acceleration unit
204 Control element/stop member
205 Contact lever
206 Arm
300 Machining device
302 Machining unit
303 Acceleration unit
304 Control cam
305 Pick-off element
306 Shoulder
307 Roller
400 Machining device
401 Moving unit
402 Machining unit
403 Follower
404 Cam carrier
405 Carrier
406 Stop member
500 Machining device
501 Follower unit
502 Stop member
503 Linear cam

What is claimed is:

1. A machining device (10, 50, 200, 300, 400, 500) for an element (52) to be machined, in particular a metal container, said device comprising:
a moving unit (12, 54, 201, 401, 5) designed to perform a cyclical movement, in particular,
a machining unit (14, 58, 202, 302, 402) which is designed to be moveable relative to the moving unit (12, 54) at least in the direction of movement of the moving unit (12, 54) inside the machining device (10, 50) and which is designed to machine the element (52) to be machined with a relative speed, in the direction of movement relative to the element (52) to be machined, which is reduced in comparison with that of the moving unit (12, 54), in particular to zero, and
a control element (18, 64, 204, 304, 404, 503),
wherein the moving unit (12, 54, 201, 401) is provided with an acceleration unit (20, 60, 203, 303, 403, 502),
wherein the control element (18, 64, 204, 304, 404, 503) and the acceleration unit (20, 60, 203, 303, 403, 502) are designed in such a way that a movement of at least one part of the acceleration unit (20, 60, 203, 303, 403, 502) with at least one component of movement transverse to the direction of movement of the moving unit (12, 54, 201, 401) is mechanically associated with a movement of the moving unit (12, 54, 201, 401) relative to the control element (18, 64, 204, 304, 404, 503), and
wherein the acceleration unit (20, 60, 203, 303, 403, 502) is designed in such a way that producing a relative acceleration of the machining unit (14, 58, 202, 302, 402) in relation to the moving unit (12, 54, 201, 401) in the direction of movement of the moving unit (12, 54, 201, 401) is mechanically associated with the movement of at least said part of the acceleration unit (20, 60, 203, 303, 403, 502).

2. The machining device (50) according to claim 1, wherein the control element (64) is part of an activating unit (56) which is coupled to the moving unit (54) and is adapted to contact the element (52) to be machined.

3. The machining device (50) according to claim 2, wherein the activating unit (56) has a lower mass than the machining unit (58), in particular a mass less than 50% of the mass of the machining unit (58), preferably a mass ranging from 5% to 40% of the mass of the machining unit (58).

4. The machining device (10) according to claim 1, comprising a holding device for the element to be machined, wherein the control element (18) is part of an activating unit which is arranged stationarily in relation to the holding device at least in the direction of movement of the moving unit (12).

5. The machining device (10, 50) according to claim 1,
wherein the acceleration unit (20, 60) has a pick-off element (24, 62) which forms a cam mechanism with the control element (18, 64) as cam carrier,
wherein the acceleration unit (20, 60) is designed to impart the relative acceleration mechanically to the machining unit, in particular by a levering effect produced by moving the pick-off element (24, 62).

6. The machining device (10, 50) according to claim 5, wherein the pick-off element (24, 62) is guided along the cam carrier and/or the pick-off element (24, 62) is provided with a spring which presses the pick-off element onto the cam carrier.

7. The machining device (10, 50) according to claim 1, wherein the acceleration unit (20, 60) transfers exclusively kinetic energy from the moving unit (12, 54) exclusively to the machining unit (14, 58) and exclusively kinetic energy from the machining unit (14, 58) exclusively to the moving unit (12, 54).

8. The machining device (10, 50) according to claim 1, wherein the machining unit (14, 58) is adapted for machining rotatingly about an axis the element to be machined (52), in particular about an axis parallel to the direction of movement of the moving unit (12, 54), in particular for milling, flange rolling, thread rolling and/or bead rolling.

9. The machining device (10, 50) according to claim 1,
wherein the movement of the moving unit (12, 54) is a cyclical movement with a movement forth and a movement back,
wherein the movement forth is provided to move the machining unit (14, 58) to the element (52) to be machined, and the relative acceleration of the machining unit (14, 58) in relation to the moving unit (12, 54) involves braking the machining unit (14, 58), and
wherein the movement back is provided to move the machining unit (14, 58) away from the element (52) to be machined, and the relative acceleration of the machining unit (14, 58) in relation to the moving unit (12, 54) involves accelerating the machining unit (14, 58).

10. A method of machining an element to be machined, in particular a metal container, said method comprising the steps of:
moving (101, 102, 105, 107, 108, 111), in particular cyclically moving, a moving unit and
machining (106) the element to be machined with a relative speed, in the direction of movement relative to the element to be machined, which is reduced in comparison with that of the moving unit, in particular to zero, by means of a machining unit which is designed to be moveable relative to the moving unit at least in the direction of movement of the moving unit inside the machining device,
wherein the method further comprises the steps of:
mechanically producing (103, 109) a movement of at least a part of an acceleration unit of the moving unit with at least one component of movement transverse to the direction of movement of the moving unit, by means of a relative movement of the moving unit in relation to a control element when moving the moving unit and
mechanically producing (104, 110) a relative acceleration of the machining unit in relation to the moving unit in the direction of movement of the moving unit, by moving at least said part of the acceleration unit.
